(19) United States
(12) Patent Application Publication
(10) Pub. No.: US 2025/0206984 A1
(43) Pub. Date: Jun. 26, 2025

(54) COATING COMPOSITIONS

(71) Applicant: PPG INDUSTRIES OHIO, INC., Cleveland, OH (US)

(72) Inventors: Venkateshwarlu Kalsani, Gibsonia, PA (US); James Dean Begley, Evans City, PA (US); Chinming Hui, Pittsburgh, PA (US); Susan Fundy Donaldson, Allison Park, PA (US); Brian Kirk Rearick, Allison Park, PA (US); Sarah Elaine Specht, Boston, MA (US)

(73) Assignee: PPG INDUSTRIES OHIO, INC., Cleveland, OH (US)

(21) Appl. No.: 18/852,085

(22) PCT Filed: Mar. 27, 2023
(86) PCT No.: PCT/US2023/064981

§ 371 Date: Sep. 27, 2024

Related U.S. Application Data
(60) Provisional application No. 63/362,083, filed on Mar. 29, 2022.

(51) Int. Cl. C09D 183/12; C09D 4/06; C09D 7/65

(52) U.S. Cl. CPC C09D 183/12; C09D 4/06; C09D 7/65

(57) ABSTRACT

A coating composition that includes: (a) a functional silane; (b) a non-aromatic epoxide resin; and (c) a cure system including (i) an organic catalyst, and (ii) alkoxy functional aminosilane; where the functional silane conforms to: where UE represents a moiety that includes one or more urethane, ester, thioester and/or thioether groups and q can be from 1 to 6; where each R²⁴ is independently selected from —CH₂—, —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂—, —CH₂CH₂CH₂CH₂CH₂—, and —(CR⁵⁰₂)ᵥ—NR⁵⁰—(CR⁵⁰₂)ᵥ—; wherein each v is independently from 1 to 6 and each R⁵⁰ is independently selected from hydrogen and C₁-C₄ alkyl; and where each R²⁵ is independently selected from hydrogen and C₁-C₄ alkyl.

### CROSS-REFERENCE TO RELATED APPLICATION

This application claims the benefit of priority of U.S. Provisional Application 63/362,083 filed Mar. 29, 2022, under 35 U.S.C. 119, titled “Coating Compositions”, which is incorporated herein by reference.

### TECHNICAL FIELD

The present disclosure is directed to coating compositions useful for protective coatings and the like, substrates coated with such coatings, uses thereof, and related coating methods.

### BACKGROUND

Epoxy siloxane coatings have gained commercial acceptance as protective and decorative coatings for steel, aluminum, galvanizing, wood and concrete in the maintenance, marine, construction, architectural, aircraft, automotive, flooring, and product finishing markets. Such coatings typically demonstrate varied cure rates or concentration requirements for the hardeners to accommodate different relative humidity conditions. Hardeners that provide cure rates substantially independent of relative humidity are desired.

### SUMMARY

The present disclosure provides coating compositions that include:
(a) a functional silane;
(b) a non-aromatic epoxide resin; and
(c) a cure system that includes (i) an organic catalyst, and (ii) alkoxy functional aminosilane; where the functional silane conforms to the formula:

UE-[-R²⁴Si(OR²⁵)₃]_{q}
where UE represents a moiety that includes one or more urethane, ester, thioether and/or thioester groups and q can be from 1 to 6;
where each R²⁴ is independently selected from —CH₂—, —CH₂CH₂—, —CH₂CH₂CH₂—, —CH₂CH(CH₃)—,
—CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂—, —CH₂CH₂CH₂CH₂CH₂—, and —(CR⁵⁰₂)ᵥ—NR⁵⁰—(CR⁵⁰₂)ᵥ; where each v is independently from 1 to 6 and each R⁵⁰ is independently selected from hydrogen and C₁-C₄ alkyl; and
where each R²⁵ is independently selected from hydrogen and C₁-C₄ alkyl.

### DETAILED DESCRIPTION

The present disclosure provides coating compositions including a unique cure system.

The cure systems according to this disclosure provide an alternative to traditional tin catalysts, affording improved dry hard times at lower concentrations of the organic or metal catalyst, such as when compared to compositions absent certain components of the cure system. For example, cure systems including a functional silane provide dry hard times at least equivalent to metal catalyst cure systems absent the functional silane.

Additionally, an organic based catalyst, as nonlimiting examples, amine based catalysts, such as tertiary amines and quaternary ammonium salt based curing systems, can be used either alone or in place of metal catalysts.

Throughout this description and in the appended claims, use of the singular includes the plural and plural encompasses singular, unless specifically stated otherwise. For example, although reference is made herein to “an” epoxy resin, “a” siloxane, and “the” metal catalyst, one or more of any of these components or any other components described herein can be used.

Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and appended claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

The words “including” and “comprising” as well as forms of the words “including” and “comprising”, as used in this description and in the claims, does not limit the present disclosure to exclude any variants or additions. Additionally, although the present disclosure has been described in terms of “including” or “comprising”, coating compositions detailed herein may also be described as consisting essentially of or consisting of. For example, while the disclosure has been described in terms of a coating composition including an epoxy resin, a polysiloxane, and a cure system, a coating composition consisting essentially of an epoxy resin, a polysiloxane, and a cure system is also within the present scope. In this context, “consisting essentially of” means that any additional coating components will not materially affect the cure rate, i.e., at least the dry hard times, or the independence of the cure rate from the relative humidity of the coating composition or coating deposited therefrom.

Furthermore, the use of “or” means “and/or” unless specifically stated otherwise. As used herein, the term “polymer” refers to prepolymers, oligomers and both homopolymers and copolymers, and the prefix “poly” refers to two or more. “Including”, “comprising” and like terms means including, but not limited to. When ranges are given, any endpoints of those ranges and/or numbers within those ranges can be combined within the scope of the present disclosure.

Unless otherwise indicated, molecular weights are reported as weight average molecular weights determined by gel permeation chromatography relative to appropriate polystyrene standards with the unit of g/mol.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

All ranges are inclusive and combinable. For example, the term “a range of from 0.06 to 0.25 wt. %, or from 0.06 to 0.08 wt. %” would include each of from 0.06 to 0.25 wt. %, from 0.06 to 0.08 wt. %, and from 0.08 to 0.25 wt. %.

As used herein, the term “ambient conditions” refers to conditions of temperature, relative humidity, and pressure of about a temperature of 22° C., a relative humidity of about 45%, and pressure of about 101.3 kPa (1 atm).

As used herein, the term “functional silane” includes the terms “aminofunctional silane”, which refers to a compound having a molecular structure that includes an amine group and a silicon atom and “thiolfunctional silane”, which refers to a compound having a molecular structure that includes a thiol group and a silicon atom.

As used herein, the term “ASTM” refers to publications of ASTM International, West Conshohocken, PA.

As used herein, the term “basecoat” refers to a coating layer that can be applied onto a primer, another basecoat layer; or directly onto a substrate, optionally including components (such as colorants) that impact the color or provide other visual impact.

As used herein the term “clear coat” refers to a coating layer that can be at least substantially transparent or fully transparent and often does not include a colorant. The term “substantially transparent” refers to a coating, where a surface beyond the coating layer can be at least partially visible to the naked eye when viewed through the coating. The term “fully transparent” refers to a coating, where a surface beyond the coating layer can be completely visible to the naked eye when viewed through the coating.

As used herein, the term “coating” refers to the finished product resulting from applying one or more coating compositions to a substrate and forming the coating, as a nonlimiting example by curing. A primer layer, basecoat or color coat layer or clear coat layer can comprise part of a coating. As used herein, the term “coating layer” can be used to refer to the result of applying one or more coating compositions on a substrate in one or more applications of such one or more coating compositions. As a nonlimiting example, a single coating layer, referred to as a “color coat” or “top coat” can be used to provide the function of both a basecoat and a clearcoat and can include the result of two or more applications of a color coat coating composition.

As used herein, the term “colorant” refers to any substance that imparts color or other opacity or other visual effect to a coating composition and can include, without limitation, dyes and pigments.

As used herein, the term “completely free” means that the material being discussed is not present, or at a minimum, not detectable, in a composition.

As used herein, the term “coordinated” may be understood to mean that a metal ion can be bonded to several donor atoms of, as a nonlimiting example, a polyurethane, and may also be understood to mean only that the metal catalyst may be in close proximity to a polyurethane and may not be part of a coordination complex with the polyurethane.

As used herein, the term “crosslinking agent” refers to a molecule or polymer containing functional groups that are reactive with the crosslinking-functional group of the polymers or resins in the coating composition.

As used herein, the term “crosslinking-functional group” refers to functional groups that are positioned in the backbone of a polymer, often, in a group pendant from the backbone of the polymer, terminally positioned on the backbone of the polymer, or combinations thereof, where such functional groups are capable of reacting with other crosslinking-functional groups or separate crosslinking agents during curing to produce a crosslinked coating.

As used herein, the terms “curable”, “cure”, and the like, as used in connection with a coating composition, refer to at least a portion of the components that make up the coating composition are polymerizable or crosslinkable when, as a nonlimiting example, exposed to higher temperatures or ultraviolet radiation.

As used herein, the term “coating layer” refers to the result of applying one or more coating compositions on a substrate in one or more applications of such one or more coating compositions.

As used herein the terms “dry” or “drying” refers to the removal of volatile compounds from a film, coating layer or an applied coating.

As used herein the term “dye” refers to a colored substance, in many cases an organic compound, that can chemically bond to a substrate or another component in a coating composition.

As used herein, the term “ester silane” refers to a material that includes compounds having ester and/or thioester, siloxane and optionally secondary amine, thioether and/or polyether moieties and can include the Michael addition product of unsaturated mono-, di-, or poly-carboxylic acid esters with alkylol trialkoxyester silanes and compounds generally conforming to the structure:

E-[-R²⁴Si(OR²⁵)₃]_{q}
where E represents a moiety that includes one or more ester, thioether and/or thioester groups and q can be from 1 to 6,
where each R²⁴ is independently selected from —CH₂—, —CH₂CH₂—,
—CH₂CH₂CH₂—, —CH₂CH(CH₃)—,
—CH₂CH(CH₃)CH₂—, —CH₂CH₂CH(CH₃)—, —CH₂CH₂CH₂CH₂—, —CH₂CH₂CH₂CH(CH₃)—,
—CH₂CH₂CH(CH₃)CH₂—, —CH₂CH₂CH₂CH₂CH₂—, and —(CR⁵⁰₂)ᵥ—NR⁵⁰—(CR⁵⁰₂)ᵥ; where each v is independently from 1 to 6 and each R⁵⁰ is independently selected from hydrogen and C₁-C₄ alkyl; and
where each R²⁵ is independently selected from hydrogen and C₁-C₄ alkyl.

As used herein, the term “film-forming” materials refers to film-forming constituents of a coating composition and can include, as nonlimiting examples, polymers, resins, crosslinking materials or any combination thereof that are film-forming constituents of the coating composition. Film-forming materials can be dried or cured, as nonlimiting examples, by exposure to elevated temperatures, actinic radiation or under ambient conditions.

As used herein, the term “hetero atom” refers to any atom in an organic molecule that is not carobon or hydrogen.

As used herein, the term “(meth)acrylate” is intended to include both methacrylates and acrylates, as nonlimiting examples, esters of acrylic acid and methacrylic acid.

As used herein, the term “Michael addition” is meant to refer to the reaction between a Michael donor (an enolate, alcohol, thiol, amine, enamine or other nucleophile) and a Michael acceptor (usually an α,β-unsaturated carbonyl) to produce a Michael reaction product by creating a carbon-carbon bond at the acceptor's β-carbon. As a nonlimiting example, the reaction of an amine group with an ethylenically unsaturated group which occurs according to this disclosure can be referred to as a Michael addition reaction resulting in a Michael addition product.

As used herein, the term “multi-component” refers to coating compositions that include more than one component, such as those that include two components (“2K systems”), where the components are stored separately and then mixed at or near the time of use. The present coating compositions can be multi-component, such as 2K systems. When reference is made herein to the “blended coating composition” it refers to the composition resulting when all the components are mixed, such as just prior to application. As a nonlimiting example, the crosslinkable resins and crosslinking agents are capable of reacting when combined to form a thermoset composition.

As used herein the term “non-ferrous metal” refers to alloys or metals that do not contain iron or are substantially free (as a nonlimiting example, contain less than 0.01 wt. %) of iron and include, without limitation, aluminum, copper, lead, nickel, tin, titanium, zinc, gold, silver, platinum, cobalt, mercury, tungsten, beryllium, bismuth, cerium, cadmium, niobium, indium, gallium, germanium, lithium, selenium, tantalum, tellurium, vanadium, and zirconium, as well as copper alloys such as brass and bronze.

As used herein the terms “one component”, “1-K” and “1-pack” refer to a coating composition where all of the coating components are maintained in the same package after manufacture, during shipping and storage.

As used herein, the terms “organic catalyst” and “organic based curing system” refer to organic compounds that include at least one hetero atom, nonlimiting examples include bicycloguanidines, imidazoles, aliphatic or cyclic amines, phosphonium salts, phenolic or sulphonic acids or salts, tertiary amines, and quaternary ammonium salts.

As used herein, the term “organic solvent” refers to carbon-based substances, that can include hetero atoms, capable of dissolving or dispersing other substances.

As used herein, the term “pigment” refers to a colored material, often an inorganic compound, that is completely or nearly (less than 0.1 wt. % dissolved) insoluble in a solvent at ambient conditions.

As used herein, the term “polyamine” refers to compounds that include two or more primary or secondary amino groups.

As used herein, the term “polyisocyanate” refers to blocked (or capped) polyisocyanates as well as unblocked polyisocyanates.

As used herein, the term “primer coat” refers to an undercoating layer that can be applied onto a substrate in order to prepare the surface for application of a protective or decorative coating composition.

As used herein, the term “reactive diluent” refers to substances which replace volatile organic compounds or solvents in a coating composition and become part of the resulting coating during its subsequent curing.

As used herein, the term “silicone” and like terms refers to polysiloxane polymers, which are based on a structure that includes alternate silicon and oxygen atoms. As used herein, “silicone” and “siloxane” are used interchangeably.

As used herein, the term “silanol-functional silicone” and like terms refers to silicones that include one or more silanol functional groups, —SiOH.

As used herein, the term “substantially free” means that the material being discussed is present in a composition, if at all, as an incidental impurity. In other words, the material does not affect the properties of the composition, such as less than 0.1 wt. % of the composition.

As used herein, the term “substrate” refers to an article surface to be coated and can refer to a coating layer disposed on an article that is also considered a substrate.

As used herein, the terms “thermoset” and “thermosetting” refer to a polymer or resin that has functional groups that react with functional groups in a crosslinking agent or another polymer or molecule to form a network material, irreversibly transforming the “soft” polymer to a more rigid form. Thermosetting in many cases refers to resins that “set” irreversibly upon curing or crosslinking, where the polymer chains of the resins are joined together by covalent bonds. Once cured or crosslinked, a thermosetting resin will not typically melt upon the application of heat and can be insoluble in solvents.

As used herein, the term “total solids” or “solids” or “solids content” refers to the solids content as determined in accordance with ASTM D5095 (2013).

As used herein, the term “topcoat” refers to an uppermost coating layer that can be applied over another coating layer such as a basecoat to provide a protective or decorative layer.

As used herein, the term “urethane silane” refers to a material that includes compounds having urethane, siloxane and optionally polyether moieties and can include compounds generally conforming to the structure:

U-[-R²⁴Si(OR²⁵)₃]_{q}
where U represents a moiety that includes one or more urethane groups and q can be from 1 to 6;
where each R²⁴ is independently selected from —CH₂—, —CH₂CH₂—,
—CH₂CH₂CH₂—, —CH₂CH(CH₃)—,
—CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂—, —CH₂CH₂CH₂CH₂CH₂—, and —(CR⁵⁰₂)ᵥ—NR⁵⁰—(CR⁵⁰₂)ᵥ; where each v is independently from 1 to 6 and each R⁵⁰ can be independently selected from hydrogen and C₁-C₄ alkyl; and
where each R²⁵ is independently selected from hydrogen and C₁-C₄ alkyl.

As used herein, the term “volatile” refers to materials that are readily vaporizable under ambient conditions.

As used herein, the terms “volatile organic compound” or “VOC” refers to volatile matter content in a coating composition measured using EPA Method 24 dated Oct. 7, 2020.

As used herein, the phrase “wt. %” refers to weight percent.

This disclosure provides coating compositions that include:
(a) a functional silane;
(b) a non-aromatic epoxide resin; and
(c) a cure system comprising (i) an organic catalyst, and (ii) an alkoxy functional aminosilane;
where the functional silane conforms to the formula:

UE-[-R²⁴Si(OR²⁵)₃]_{q}
where UE represents a moiety that includes one or more urethane, ester, thioether and/or thioester thioether groups and q can be from 1 to 6;
where each R²⁴ can independently be selected from —CH₂—, —CH₂CH₂—,
—CH₂CH₂CH₂—, —CH₂CH(CH₃)—,
—CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂—, —CH₂CH₂CH₂CH₂CH₂—, and —(CR⁵⁰₂)ᵥ—NR⁵⁰—(CR⁵⁰₂)ᵥ—; where each v can be independently from 1 to 6 and each R⁵⁰ can be independently selected from hydrogen and C₁-C₄ alkyl; and
where each R²⁵ can be independently selected from hydrogen and C₁-C₄ alkyl.

The functional silane may, without limitation, include functional silanes conforms to the formula:

(R²⁵O)₃Si—R²⁴-A-[-B—R²⁴Si(OR²⁵)₃]ₜ
where each A can independently be C(R²³)₂, N(R²³), —O— or —S— and each R²³ can be independently selected from hydrogen and C₁-C₄ alkyl and t can be from 0 to 5, such as 0 to 4, 0 to 3, 0 to 2, or 0 to 1;
each B can be independently selected from —C(O)—O—(R³⁰O)_{y}—, —C(O)—O—R³⁰-A-, —R³⁰—C(O)—O—R³⁰—O—C(O)—R³⁰-A, —C(O)—O—[R³⁰—O—C(O)-A-R³⁰-A-C(O)—OR³⁰O]_{z}—C(O)-A-, —C(O)—[O—R³⁰—O—C(O)-A-R³⁰-A-C(O)]_{z}-A-, and
—[C(O)—N(R²³)—R³⁰—N(R²³)—C(O)—O—R³⁰—O—C(O)—N(R²³)—R³⁰—N(R²³)—C(O)]_{z}—N(R²³)—, where each y can independently be an integer from 1 to 20, each z can independently be an integer from 1 to 20, and each R³⁰ can independently be any C₁ to C₁₂ difunctional organic radical independently selected from aryl, linear or branched alkyl, linear or branched dialkylaryl, cyclo aliphatic and cycloalkyl radicals;
each R²⁴ can be independently selected from —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂— or —CH₂CH₂CH₂CH₂CH₂—; and
each R²⁵ can be independently selected from hydrogen and C₁-C₄ alkyl.

When the functional silane includes a urethane silane, it can, without limitation, conform to the structure:

(R²⁵O)₃Si—R²⁴—N(R²³)-D-R²⁴Si(OR²⁵)₃
where each R²³ can be independently selected from hydrogen and C₁-C₄ alkyl;
each D can be independently selected from —C(O)—O—(R³⁰O)_{y}—, —C(O)—O—R³⁰—N(R²³)—, —R³⁰—N(R²³)—C(O)—O—R³⁰—O—C(O)—R³⁰—N(R²³)—, —C(O)—O—[R³⁰—O—C(O)—N(R²³)—R³⁰—N(R²³)—C(O)—OR³⁰O]_{z}—C(O)—N(R²³)—, —C(O)—[O—R³⁰—O—C(O)—N(R²³)—R³⁰—N(R²³)—C(O)]_{z}—N(R²³)—, and —[C(O)—N(R²³)—R³⁰—N(R²³)—C(O)—O—R³⁰—O—C(O)—N(R²³)—R³⁰—N(R²³)—C(O)]_{z}—N(R²³)—, where each y can independently be an integer from 1 to 20, each z can independently be an integer from 1 to 20, and each R³⁰ can independently be any C₁ to C₁₂ difunctional organic radical independently selected from aryl, linear or branched alkyl, linear or branched dialkylaryl, cyclo aliphatic and cycloalkyl radicals;
each R²⁴ can be independently selected from —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂— or —CH₂CH₂CH₂CH₂CH₂—; and
each R²⁵ can be independently selected from hydrogen and C₁-C₄ alkyl.

When the functional silane includes a urethane silane, it can, without limitation, conform to the formula:

(R³⁴O)₃SiR³³N(R³²)C(O)O(CH₂CR³¹₂CR³¹₂CR³¹₂CR³¹₂CH₂O)ₖC(O)N(R³²)R³³Si(OR³⁴)₃

Where each R³¹ can independently be selected from H, methyl, or ethyl, each R³² can be independently selected from hydrogen or methyl, where k can be an integer from 1 to 10; each R³³ can be independently selected from —CH₂CH₂—, —CH₂CH₂CH₂—, —CH₂CH(CH₃)—, —CH₂CH(CH₃)CH₂—, —CH₂CH₂CH₂CH₂—, —CH₂CH₂CH(CH₃)CH₂— and —CH₂CH₂CH₂CH₂CH₂—; and each R³⁴ can be independently selected from hydrogen or methyl.

As nonlimiting examples, the urethane silane can include one or more compounds having a structure according to any of the following formulas:

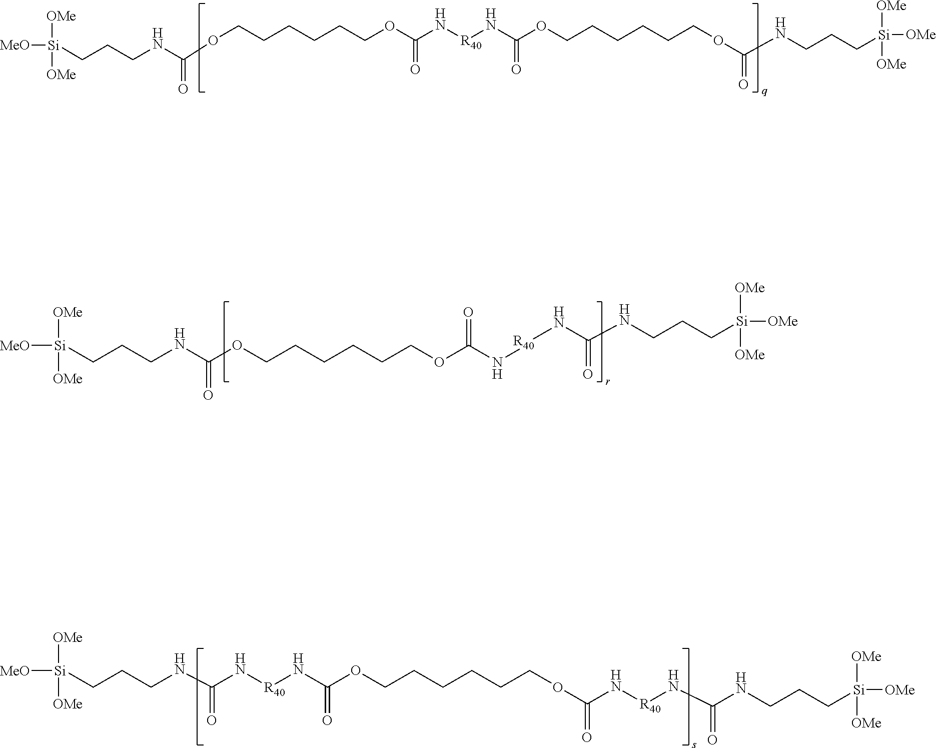

where each R⁴⁰ can independently be any C₁ to C₁₂ difunctional organic radical independently selected from aryl, linear or branched alkyl, linear or branched dialkylaryl, cyclo aliphatic and cycloalkyl radicals, such as, without limitation toluene, 4,4′-methylene-bis(cyclohexane), isophorone, 2,2,4-trimethyl hexane, 2,4,4-trimethyl hexane, 1,6-hexane, tetramethyl xylylene and 4,4′-diphenylmethylene.

The urethane silane can be a product prepared by reacting:
1) one or more C₁-C₂₀ linear, branched or cyclic alkyl mono- di- or poly-functional alcohols, amines, and/or thiols, with
2) an isocyanate component containing one, two, three or more up to five or six isocyanate groups, where the reaction product of 1) and 2) can then be reacted with
3) a compound containing an isocyanate-reactive group or an isocyanate group and one or more reactive silane groups in which at least 10 mole %, but less than 100% of component 3) is a compound corresponding to formula:

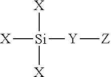

where
X represents the same or different organic groups that do not react with isocyanate groups below 100° C., provided that at least two of the groups are alkoxy or acyloxy groups,
Y represents a linear or branched alkylene group containing 1 to 8 carbon atoms, and
Z represents an isocyanate group, an amine group, a hydroxy group, or a thiol group.

The urethane silane can be a product prepared by reacting:
1) an isocyanate component containing one, two, three or more up to five or six isocyanate groups, with
2.) a compound containing an isocyanate-reactive group or an isocyanate group and one or more reactive silane groups in which at least 10 mole %, but less than 100% of component 2) is a compound corresponding to the formula

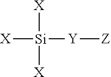

where
X represents the same or different organic groups that are inert to isocyanate groups below 100° C., provided that at least two of the groups are alkoxy or acyloxy groups,
Y represents a linear or branched alkylene group containing 1 to 8 carbon atoms, and
Z represents an isocyanate group, an amine group, a hydroxy group, or thiol group;
   where the molar ratio of urethane silane to urea silane can range from 100:0, such as 99:1, 90:10 or 75:25 to 1:99, such as 10:90 or 25:75 and the ratio can be from 100:0 to 1:99, such as 100:0 to 25:75, 99:1 to 25:75, 90:10 to 25:75 or 75:25 to 10:90.

The isocyanate component can include suitable mono-, di-, and poly-isocyanates including aromatic, aliphatic or cycloaliphatic di-, tri- or tetra-isocyanates, including polyisocyanates having isocyanurate structural units, such as, one or more of the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate. Other polyisocyanates disclosed herein can also be suitable for producing the urethane silane.

The isocyanate component (1) can include suitable polyisocyanate-functional adducts having isocyanaurate structural units, nonlimiting examples include the adduct of 2 molecules of a diisocyanate, such as, one or more of hexamethylene diisocyanate or isophorone diisocyanate, and a diol such as ethylene glycol; the adduct of 3 molecules of hexamethylene diisocyanate and 1 molecule of water (commercially available from Bayer Corporation of Pittsburgh, Pa. under the trade name Desmodur N); the adduct of 1 molecule of trimethylol propane and 3 molecules of toluene diisocyanate (commercially available from Bayer Corporation of Pittsburgh, Pa. under the trade name Desmodur L); the adduct of 1 molecule of trimethylol propane and 3 molecules of isophorone diisocyanate or compounds, such as 1,3,5-triisocyanato benzene and 2,4,6-triisocyanatotoluene; and the adduct of 1 molecule of pentaerythritol and 4 molecules of toluene diisocyanate.

The isocyanate component (1) can include, as nonlimiting examples, aliphatic and aromatic polyisocyanate and mixtures thereof. As particular nonlimiting examples, higher polyisocyanates such as isocyanurates of diisocyanates can be used; diisocyanates, uretdione and biuret can also be used. Isocyanate prepolymers, nonlimiting examples including the reaction products of polyisocyanates with polyols also can be used. Mixtures of polyisocyanate crosslinking agents can be used.

As nonlimiting examples, the polyisocyanate can be prepared from a variety of isocyanate-containing materials. Nonlimiting examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

The mono-, di-, or poly-functional alcohols can include without limitation aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols, such as cresol and nitrophenol; ethylene glycol, propylene glycol, butylene glycol, 1,6-hexyleneglycol, neopentyl glycol, diethylene glycol, glycerol, trimethylol propane, and/or pentaerythritol.

Additional nonlimiting examples of urethane silane resins that are useful in this disclosure include those available under the trade name Vestanat available from Evonik Corporation, Parsipanny, NJ; as nonlimiting examples Vestanat MF 201, Vestanat MF 202, Vestanat MF 203, Vestanat MF 204, and Vestanat MF 205.

When the functional silane includes an ester silane, the ester silane can include compounds conforming to the formula:

(R²⁵O)₃Si—R²⁴-A-[-R²⁴—C—R²⁴-A-R²⁴—Si(OR²⁵)₃]_{q}
where each A can independently be C(R²³)₂, N(R²³), —O— or —S—;
each R²³ can be independently selected from hydrogen and C₁-C₄ alkyl;
each C can be independently selected from —C(O)—O—(R³⁰O)_{y}—, —C(O)—O—(R³⁰O)_{y}—C(O)—, and —C(O)—O—R³⁰—O—C(O)—, where each y can independently be an integer from 1 to 20, and each R³⁰ can independently be any C₁ to C₁₂ difunctional organic radical independently selected from aryl, linear or branched alkyl, linear or branched dialkylaryl, cyclo aliphatic and cycloalkyl radicals;
each R²⁴ can be independently selected from —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂— or —CH₂CH₂CH₂CH₂CH₂—; and
each R²⁵ can be independently selected from hydrogen and C₁-C₄ alkyl.

When the functional silane includes an ester silane, the ester silane can include more than one site of ethylenic unsaturation including a polyethylenically unsaturated monomer, such as di- and higher (meth)acrylates or a mono-(meth)acrylate. Specific nonlimiting examples of suitable polyethylenically unsaturated monomers are diacrylates, such as 1,6-hexanediol diacrylate, 1,6-hexanedithiol diacrylate, 1,4-butanediol diacrylate, 1,4-butanedithiol diacrylate, ethylene glycol diacrylate, ethylene dithiol diacrylate, diethylene glycol diacrylate, tetraethylene glycol diacrylate, tripropylene glycol diacrylate, neopentyl glycol diacrylate, 1,4-butanediol dimethacrylate, 1,4-butanedithiol dimethacrylate, poly(butanediol) diacrylate, tetraethylene glycol dimethacrylate, 1,3-butylene glycol diacrylate, 1,3-butylene dithiol diacrylate, triethylene glycol diacrylate, triisopropylene glycol diacrylate, polyethylene glycol diacrylate, and/or bisphenol A dimethacrylate; tri(meth)acrylates, such as trimethylolpropane triacrylate, trimethylolpropane trimethacrylate, pentaerythritol monohydroxy triacrylate, and/or trimethylolpropane triethoxy triacrylate; tetraacrylates, such as pentaerythritol tetraacrylate, and/or di-trimethylolpropane tetraacrylate; and/or pentaacrylates, such as dipentaerythritol (monohydroxy) pentaacrylate or a mixture or combination thereof.

Nonlimiting examples of suitable monoethylenically unsaturated monomers are (meth)acrylates, including, any C₁-C₃₀ aliphatic alkyl ester of (meth)acrylic acid, non-limiting examples of which include methyl(meth)acrylate, ethyl(meth)acrylate, propyl(meth)acrylate, N-butyl(meth)acrylate, t-butyl(meth)acrylate, 2-ethylhexyl(meth)acrylate, isobornyl (meth)acrylate, glycidyl (meth)acrylate, dimethylaminoethyl (meth)acrylate, N-butoxy methyl (meth)acrylamide, lauryl (meth)acrylate, cyclohexyl (meth)acrylate, neopentyl (meth)acrylate and 3,3,5-trimethylcyclohexyl (meth)acrylate.

In addition to or in lieu of the aforementioned polyethylenically unsaturated monomers, the ester silane can include the Michael addition reaction product of reactants including a polyethylenically unsaturated oligomer. The polyethylenically unsaturated oligomers suitable for use herein can include, as nonlimiting examples, urethane acrylates, polyester acrylates and mixtures thereof, particularly those that are free of hydroxyl functional groups. Specific nonlimiting examples of such materials include urethane acrylates, such as Ebecryl 220 and Ebecryl 264 available from Cytec Surface Specialties Inc. and polyester acrylates, such as Ebecryl 80 available from UCB Chemicals.

In the coating compositions of the present disclosure, the compound(s) including one or more than one site of ethylenic unsaturation can be reacted with an aminofunctional silane in the Michael addition reaction. The aminofunctional silane can include a compound having the formula:

NH₂—R¹—Si(R″)ₚ(O—R′″)₃₋ₚ

where R′ is an alkylene group having from 2 to 10 carbon atoms, R″ is an alkyl, aryl, alkoxy, or aryloxy group having from 1 to 8 carbon atoms, R″′ is an alkyl group having from 1 to 8 carbon atoms, and p has a value of from 0 to 2. R′ can be an alkylene group having from 2 to 5 carbon atoms and p can be 0.

The aminofunctional silane can include a γ-aminopropyltrialkoxysilane. Examples of aminofunctional silanes which are suitable for use in the present dislosure include, but are not limited to, aminoethyltriethoxysilane, γ-aminopropyltriethoxysilane, γ-aminopropylmethyldiethoxysilane, γ-aminopropylethyldiethoxysilane, δ-aminopropylphenyldiethoxysilane, γ-aminopropyltrimethoxysilane, δ-aminobutyltriethoxysilane, and δ-aminobutylethyldiethoxysilane.

In the coating compositions of the present disclosure, the compound(s) including one or more than one site of ethylenic unsaturation can be reacted with a thiolfunctional silane in the Michael addition reaction. The thiolfunctional silane can include a compound having the formula:

SH—R′—Si(R″)ₚ(O—R′″)₃₋ₚ

where R′ is an alkylene group having from 2 to 10 carbon atoms, R″ is an alkyl, aryl, alkoxy, or aryloxy group having from 1 to 8 carbon atoms, R′″ is an alkyl group having from 1 to 8 carbon atoms, and p has a value of from 0 to 2. R′ can be an alkylene group having from 2 to 5 carbon atoms and p can be 0. A reaction product similar to the Michael addition reaction product using the thiolfunctional silane can be generated using known free radical reactions.

In this disclosure it may be the case that little or no other reactant, such as a polyamine, is added to the reactant mixture for the Michael addition reaction. As a result, the reactants taking part in the Michael addition reaction can be substantially free, or, in some cases, completely free of any polyamine. The presence of any significant quantity of polyamine can, in at least some cases, result in increased yellowing, the generation of additional unwanted byproducts, and/or an undesirable accelerated building of viscosity in the Michael addition reaction product.

The Michael addition reaction product can be formed by simply blending the reactants at room temperature or at a slightly elevated temperature, for example, up to 100° C. Such products can be more heat and light stable than greater acrylyl content-containing products. It should be recognized that slowly adding the functional silane to the compound including one or more than one site of ethylenic unsaturation results in there being a large excess of acrylate groups to functional silane. Unless the temperature of the reaction mixture is kept sufficiently low, a gelled product can be the result. It is sometimes better, therefore, to add the unsaturated material to a reaction vessel already containing a functional silane to obtain an ungelled reaction product. The reaction can be carried out in the absence of a solvent or in the presence of an inert solvent. Nonlimiting examples of suitable inert solvents include toluene, butyl acetate, methyl isobutyl ketone, and ethylene glycol monoethyl ether acetate. It is often desirable that the reaction be conducted in the absence of moisture or in a controlled amount of moisture to avoid unwanted side reactions and possibly gelation.

The Michael addition reaction can be conducted such that the equivalent ratio of the ethylenically unsaturated groups to the amine groups is at least 1:1, such as, at least 1.05:1.

Michael addition products and Michael addition reactions are described in U.S. Pat. No. 8,349,066 at from col. 4, line 9 to col. 7, line 21, the specific portions of which are incorporated herein by reference.

The ester silane can include, without limitation, one or more compounds having a structure according to either of the following formulas:

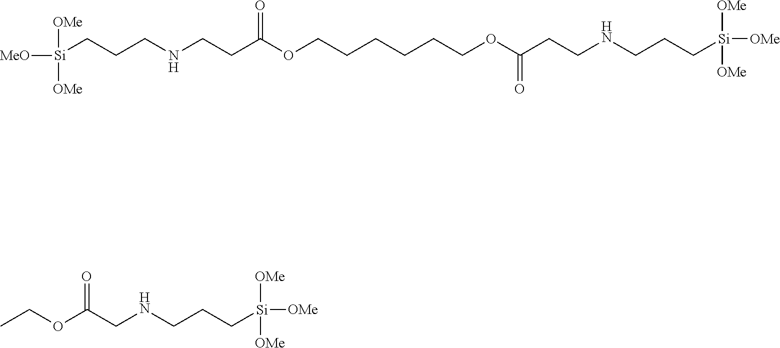 [SMILES: CO[Si](CCCNCCC(=O)OCCCCCCOC(=O)CCNCCC[Si](OC)(OC)OC)(OC)OC ; CCOC(=O)CNCCC[Si](OC)(OC)OC]

The functional silane can be present in the coating composition at a level of from at least 1 wt. %, such as at least 2 wt. % or at least 3 wt. % and/or where the functional silane is present in the coating composition in an amount of up to 20 wt. %, such as up to 15 wt. % or up to 10 wt. %, the functional silane can be present in the coating composition in an amount in a range of from 1 to 20 wt. %, such as 1 to 15 wt. %, 1 to 10 wt. %, 3 to 20 wt. % or 3 to 10 wt. %, where the weight percentages are based on the total weight of the coating composition.

Nonlimiting examples of epoxy resins useful in forming coating compositions of this disclosure can include non-aromatic epoxy resins that contain more than one 1,2-epoxy groups per molecule, such as two 1,2-epoxy groups per molecule. The terms “epoxide resin” and “epoxy resin,” as used herein, are interchangeable. The epoxy resins can be liquid rather than solid and can have an epoxide equivalent weight of 100 to 5,000 g/mol, such as 100 to 2,000 g/mol, or even 100 to 500 g/mol.

Nonlimiting examples of epoxide resins include non-aromatic hydrogenated cyclohexane dimethanol and diglycidyl ethers of hydrogenated Bisphenol A-type epoxide resin, such as Eponex 1510, and Eponex 1513 (hydrogenated bisphenol A-epichlorohydrin epoxy resin) of Hexion; and Epodil 757 (cyclohexane dimethanol diglycidylether) of Evonik; Araldite epoxies of Ciba Geigy; Aroflint 393 and 607 of Reichold; and ERL-4221 (3,4-Epoxycyclohexanemethyl 3,4-epoxycyclohexanecarboxylate) commercially available from Polysciences, Inc. Other suitable non-aromatic epoxy resins can include EP-4080E (cycloaliphatic epoxy resin) commercially available from Adeka, Japan; and DER 732 and DER 736 of Palmer Holland.

In specific nonlimiting examples, the epoxy resin can be EP-4080E (cycloaliphatic epoxy resin). Such non-aromatic hydrogenated epoxide resins may be desired for their limited reactivity of about two, which promote formation of a linear epoxy polymer and prohibits formation of a cross-linked epoxy polymer. The coating composition can include 20% to 70% by weight of the epoxide resin, such as 15% to 60% by weight of epoxide resin.

The organic catalyst can include, as nonlimiting examples, bicycloguanidine, an imidazole, an acid catalyst such as Nacure XC-346 (King Industries), an aliphatic or cyclic amine, a phosphonium salt, a phenolic or sulphonic acid or salt, or a tertiary amine or a quaternary ammonium salt or tetrabutylammonium fluoride or 1,8-diazabicyclo[5.4.0]undec-7-ene.

When an organic catalyst is included, either alone or in combination with a metal catalyst, the coating composition can include a cure system that includes a silane terminated polyurethane coordinate with an organic catalyst at from at least 1 ppm, such as at least 5 ppm, or at least 9 ppm to up to 1000 ppm, such as up to 500 ppm or up to 150 ppm, the cure system that includes a silane terminated polyurethane coordinate with an organic catalyst can be in a range of from 1 to 1000 ppm, such as from 1 to 500 ppm, from 1 to 150 ppm, from 5 to 1000 ppm, from 5 to 500 ppm or from 5 to 150 ppm of the organic catalyst based on the weight of the coating composition. The organic catalyst can replace the metal catalyst at levels described herein for the metal catalyst.

The cure system in the coating composition can include alkoxy functional aminosilane(s). The alkoxy functional aminosilane can include trialkoxy functional aminosilanes having the following formula:

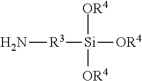

where R³ may be a difunctional organic radical independently selected from aryl, alkyl, dialkylaryl, alkoxyalkyl, alkylaminoalkyl, and cycloalkyl radicals, each alkyl, aryl, cycloalkyl, and alkoxy group containing up to 6 carbon atoms, and each R⁴ may be independently selected from alkyl, hydroxyalkyl, alkoxyalkyl or hydroxyalkoxyalkyl groups where each alkyl, aryl, cycloalkyl, and alkoxy group in the R⁴ group contains up to 6 carbon atoms. Each R³ may be independently chosen from (C₁-C₆) alkyl groups and each R⁴ can be independently chosen from (C₁-C₆)alkyl groups and (C₁-C₆)alkylamino(C₁-C₆)alkyl groups.

Other suitable trialkoxy functional aminosilanes include those having the following formula:

Y—Si—(O—R⁴)₃

where Y may be H(HNR⁸)_{c} and “c” is an integer of from 1 to 6, R⁴ is as defined above, and each R₈ may be a difunctional organic radical independently selected from aryl, alkyl, dialkylaryl, alkoxyalkyl, and cycloalkyl radicals.

Nonlimiting examples of trialkoxy functional aminosilanes include aminopropyl trimethoxysilane, aminopropyl triethoxysilane, aminopropyl tripropoxysilane, aminoneohexyl trimethoxysilane, N-β-(aminoethyl)-γ-aminopropyl trimethoxysilane, N-β-(aminoethyl)-γ-aminopropyl triethoxysilane, N-phenylaminopropyl trimethoxysilane, trimethoxysilylpropyl diethylene triamine, 3-(3-aminophenoxy)propyl trimethoxysilane, aminoethyl aminomethyl phenyl trimethoxysilane, 2-aminoethyl-3-aminopropyl-tris-2-ethylhexoxysilane, N-aminohexyl aminopropyl trimethoxysilane, trisaminopropyl trismethoxy ethoxy silane, aminoethyl aminopropyl triethoxysilane, aminoethyl aminopropyl trimethoxysilane, γ-aminopropylmethyl dimethoxysilane, γ-aminopropylmethyl diethoxysilane, N-β-(aminoethyl)-γ-aminopropymethyl diethoxysilane, and N-β-(aminoethyl)-γ-aminopropylmethyl dimethoxysilane.

Nonlimiting examples of commercially available trialkoxy functional aminosilanes include SILQUEST A-1100 (aminopropyl trimethoxysilane having an amine equivalent weight of 89.7), SILQUEST A-1110 (aminopropyl triethoxysilane having an amine equivalent weight of 111), SILQUEST A-1120 (N-β-(aminoethyl)-γ-aminopropyl trimethoxysilane), and SILQUEST A-1637, commercially available from Momentive. Additional suitable commercially available trialkoxy functional aminosilanes also include Dowsil Z6020, Dowsil Z6011, Dowsil XI-6100, and Dowsil X16150 of Dow Silicones Corporation; Silquest A1101, A1102, A1108, A1126, A1130, A1387, A-2120 and A2639 of Momentive; and CoatOSil 2810, Dynasylan AMMO, AMEO-T, DAMO, TRIAMO, 1122, 1146, 1189, and 1505 all manufactured of Evonik; and KBE-602, KBE-603 and KBE-903 manufactured by Shin-Etsu.

This disclosure also provides coating compositions that include:
(a) a functional silane as described above and optionally a polysiloxane;
(b) a reactive diluent
(c) a non-aromatic epoxide resin; and
(d) a cure system comprising (i) a polyurethane with an optional metal catalyst and/or an organic catalyst, and (ii) an alkoxy functional aminosilane;
where the coating composition contains less than 10 wt. %, such as less than 8 wt. % or 7 wt. % of volatile organic compounds based on the weight of the coating composition using EPA Method 24 dated Oct. 7, 2020.

The polysiloxane can conform to the following general formula:

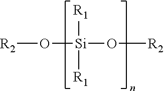

each R¹ can be independently selected from a hydroxy group or an alkyl, aryl, or alkoxy group having up to six carbon atoms, each R² can be independently selected from hydrogen, or an alkyl or aryl group having up to six carbon atoms, and n can be selected so that the molecular weight for the polysiloxane can be 400 to 10,000 g/mol. R¹ and R² may include groups having less than six carbon atoms, for example, to facilitate rapid hydrolysis of the polysiloxane, where the reaction may be driven by the volatility of the alcohol analog product of the hydrolysis. Selection of R¹ and R² groups having greater than six carbon atoms may impair hydrolysis of the polysiloxane due to the relatively low volatility of each alcohol analog. Methoxy, ethoxy and silanol functional polysiloxanes having an “n” selected such that the molecular weights are 400 to 2000 g/mol may be used for formulating coating compositions of the present disclosure.

Nonlimiting examples of methoxy functional polysiloxanes include: Dowsil 3074 and Dowsil 3037 commercially available from Dow Silicones Corporation; and GE SR191 and SY-550 commercially available from Wacker. Exemplary silanol functional polysiloxanes include, but are not limited to, Dow Silicones Corporation's Dowsil SH 840. The coating composition can include 15% by weight or greater of the polysiloxane, such as 20 wt. % or greater, or 30 wt. % or greater, or 40 wt. % or greater, or 50 wt. % or greater, or can include 70% by weight or lower of the polysiloxane, such as 60 wt. % or lower, or 50 wt. % or lower, or 40 wt. % or lower. For example, the coating composition can include 15% to 70% by weight of the polysiloxane, such as 15% to 60% by weight of the polysiloxane, or any other range combination using any of these upper and lower endpoints.

Any suitable reactive diluent capable of replacing volatile organic compounds can be used in the coating compositions according to this disclosure. As a nonlimiting example, the reactive diluent can be miscible with the coating system, can be chemically integrated into a cured coating network and contain 1 to 4 functional groups such as amine, epoxy, carbonate, acrylate and silane functional groups.

Nonlimiting examples of reactive diluents that can be used include; amine functional materials such as amino-silicone hybrid compounds such as those available under the trade name Tego from Evonik industries, such as Tego Protect 5000N, aminoalkylmethylsiloxane—dimethylsiloxane copolymers available under the trade name Gelest from Gelest, such as Gelest AMS-1203, polyether amines available under the Jeffamine trade name from Huntsman Corporation, such as Jeffamine T5000, Jeffamine D2000 and Jeffamine SD201, N,N′-dibutyldiaminodiphenylmethane available under the trade name Polylink 4200 from Aceto, amine-functional resins available under the trade name Desmophen from Covestro AG, such as Desmophen NH1220 and Desmophen NH 1420, and aliphatic diamines such as HXA CE425 available from Hanson Group, LLC; Epoxy functional materials such as 2-ethylhexyl glycidyl ether, 3,4-epoxycyclohexylmethyl-3′4′-epoxycyclohexane carboxylate, glycidyl esters of versatic acid such as Cardua E10 available from Hexion Inc., epoxy functional hydrophobic aliphatic compounds available under the trade name Cardolite from Cardolite Corporation, such as Cardolite NC-513, and oxirane epoxidized linseed oils available under the trade name Epoxol from ACS Technical Products, such as Epoxol 9-5; carbonates such as propylene carbonate; acrylates such as 1,6-hexanediol diacrylate and butylacrylate and ethylhexylacrylate; and silanes such as vinyltrimethoxy silane, dimethylsiloxane-vinylmethylsiloxane—(propylene oxide-ethylene oxide) block copolymers available from Gelest, such as Gelest DBP-V052, and tetraethoxysilane (TEOS).

The reactive diluents can be included in the coating composition to replace volatile organic compounds (VOC), thus reducing the VOC profile of the coating composition. The use of particular reactive diluents can provide for targeted improvement of certain physical properties of the final coating while maintaining or improving percent solids and lowering VOC levels. As nonlimiting examples, the use of 1,6-hexanediol diacrylate can significantly improve the flexibility of the resulting coating. Also, the use of vinyl silane can significantly improve dry times. The reactive diluents can alter the overall chemistry of the coating in a unique way compared with, for example, acrylate addition.

The reactive diluent can be present in the coating composition at from at least 0.5 wt. %, such as at least 1 wt. % and up to 8 wt. % or up to 7 wt. %, the reactive diluent can be present in the coating composition in a range of from 1.5 wt. % to 10 wt. %, such as from 0.5 to 10 wt. %, from 0.5 to 7 wt. %, from 1 to 10 wt. % or from 1 to 7 wt. % based on the weight of the coating composition.

The non-aromatic epoxide resin; organic catalysts and alkoxy functional aminosilanes described above can be included in the coating composition.

When a metal catalyst is included in the coating compositions, the metal catalyst can be included in the cure system in the form of an organometallic catalyst including, without limitation, a metal selected from zinc, manganese, zirconium, titanium, cobalt, iron, lead, aluminum, bismuth, or tin. Nonlimiting exemplary metal catalysts include the those conforming to the following formula:

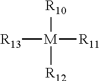

where M is the metal, R¹⁰ and R¹¹ may be independently selected from acyl, alkyl, aryl, or alkoxy groups having up to twelve carbon atoms, and R¹² and R¹³ may be selected from those groups set forth for R¹⁰ and R¹¹ or from inorganic atoms such as halogens, sulfur or oxygen. The R¹⁰, R¹¹, R¹² and R¹³ groups may be selected from butyl, acetates, laurates, octanoates, neodecanoates or naphthanates.

Nonlimiting examples of metal catalysts include organometallic tin catalysts, such as, for example, dibutyl tin dilaurate, dibutyl tin diacetate, dibutyl tin diacetyldiacetonate, dioctyltindilaurate, dioctyltindiacetate, or organotitanates. Further nonlimiting examples of metal catalysts include zinc, zirconium, bismuth, or aluminum amidine catalysts such as a zinc (II) amidine complex. A nonlimiting example of a metal amidine complex can have the formula M(A)₂(C)₂ where A represents an amidine, C represents a carboxylate, and M represents the metal, such as zinc, zirconium, bismuth, or aluminum. In a nonlimiting examples of a metal amidine complex, C may be an aliphatic, aromatic or polymeric carboxylate with an equivalent weight of 45 to 465, and A may be an amidine represented by either of the following formulas:

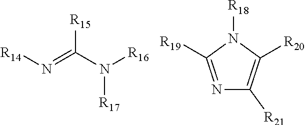

where R¹⁴ represents hydrogen, an organic group attached through a carbon atom, an amine group which can be substituted, for example by an optionally substituted hydrocarbyl group, or a hydroxyl group which can be etherified, for example with an optionally substituted hydrocarbyl group having up to 8 carbon atoms; R¹⁵ and R¹⁶ each independently represent hydrogen or an organic group attached through a carbon atom or are joined to one another to form (with the linking —N═C—N—) a heterocyclic ring, with hetero atom(s) or a fused bicyclic ring with heteroatom(s); and R¹⁷ represents hydrogen, an organic group attached through a carbon atom or a hydroxy group which can be etherified, for example with an optionally substituted hydrocarbyl group having up to 8 carbon atoms.

Nonlimiting examples of amidines include those in which the pair R¹⁵-R¹⁶ or R¹⁵-R¹⁷ forms a 5 to 7 membered ring that includes the two amidine nitrogen atoms and one of the pairs R¹⁵-R¹⁶ or R¹⁵-R¹⁷ forms a 5 to 9 membered ring that includes one amidine nitrogen atom and carbon atoms. Particular catalytic amidine groups are those in which the groups R¹⁵ and R¹⁶ are joined to form (with the linking —N═C—N—) a heterocyclic ring, for example an imidazoline, imidazole, tetrahydropyrimidine, dihydropyrimidine or pyrimidine ring. Acyclic amidines and guanidines can alternatively be used.

Nonlimiting examples of amidines further include imidazole derivatives of the general formula (VII), where R¹⁸, R¹⁹, R²⁰, and R²¹ independently represent hydrogen, alkyl, or substituted alkyl, hydroxyalkyl, aryl, aralkyl, cycloalkyl, heterocyclics, ether, thioether, halogen, —N(R)₂, polyethylene polyamines, nitro groups, keto groups, ester groups, or carbonamide groups, alkyl substituted with the various functional groups described above.

In a nonlimiting example of an amidine, R¹⁴ can be hydrogen or C₁-C₆ alkyl; R₁₅C₁-C₆ alkyl or an amine optionally substituted with C₁-C₆ alkyl or phenyl; R₁₆ and R₁₇ are hydrogen, C₁-C₆ alkyl or phenyl; and R¹⁸, R¹⁹, R²⁰ and R²¹ are independently hydrogen or C₁-C₆ alkyl. A nonlimiting example of a metal amidine catalyst includes a zinc (II) amidine complex commercially available from King Industries of Norwalk Conn. under the trade name K-KAT XK620.

When the cure system includes a metal catalyst and a trialkoxy functional aminosilane it may be included up to 40% by weight of the metal catalyst, such as 0.1% to 30% by weight, 0.1% to 20% by weight, 0.1% to 15% by weight, or 0.1% to 8% by weight based on the total weight of the cure system. For example, when the cure system includes a tin catalyst such as dibutyltin dilaurate, the cure system may include from 0.1% to 15% by weight, such as 0.1% to 8% by weight of the tin catalyst based on the total weight of the cure system. Alternatively, when the cure system includes a zinc catalyst such as zinc amidine, the cure system may include from 0.1% to 40% by weight, such as from 0.1% to 30% by weight of the zinc catalyst based on the total weight of the cure system.

When included, the cure system including a metal catalyst and a trialkoxy functional aminosilane may be included in the coating composition at 10% to 30% by weight of the coating composition, such as from 10% to 20% by weight of the coating composition. The cure system can be added in an amount sufficient to provide an amine equivalent to epoxide equivalent ratio of 0.7:1.0 to 1.3:1.0 in the coating composition, such as 0.9:1.0 to 1.1:1.0, or even 0.95:1.00 to 1.05:1.00.

The present disclosure further provides coating composition including a functional silane as described above and optionally a polysiloxane, a non-aromatic epoxide resin, and a cure system including (i) a polyurethane with an optional metal catalyst and (ii) an alkoxy functional aminosilane. The polyurethane of the cure system can include a reaction product of reactants including a polyisocyanate, a polyol, and the metal catalyst, where the metal catalyst may be coordinated with the polyurethane.

The metal catalyst, when included, may be any of those disclosed hereinabove, such as those having the formula above including manganese, zirconium, titanium, cobalt, iron, lead, bismuth, aluminum, zinc, or tin. The metal catalyst may be a metal amidine complex as defined hereinabove, i.e., having the formula M(A)₂(C)₂ where A represents an amidine, C represents a carboxylate, and M represents zinc, zirconium, bismuth, or aluminum. In a nonlimiting example of an amidine complex, A may have one of the amidine formulas above. The metal catalyst can include zinc amidine or dibutyltin dilaurate. Moreover, the alkoxy functional aminosilane (ii) of the cure system may be any of those having formulas defined herein.

The coating compositions described above can be combined to provide coating compositions that include:
(a) a functional silane,
(b) a reactive diluent;
(c) a non-aromatic epoxide resin; and
(d) a cure system that includes (i) an organic catalyst, and (ii) an alkoxy functional aminosilane;
where the coating composition contains less than 10 wt. %, such as less than 8 wt. % or 7 wt. % of volatile organic compounds based on the weight of the coating composition.

There can be no detectable volatile organic compounds in the coating compositions described herein, but when present, the volatile organic compounds can be present at from at least 1 ppm, such as at least 10 ppm, at least 100 ppm, at least 1 wt. % or up to 2 wt. % up to 10 wt. %, such as up to 8 wt. %, up to 7 wt. % or up to 5 wt. % and when present can range from 1 ppm to 10 wt. % such as 1 wt. % to 10 wt. %, 2 wt. % to 10 wt. %, 1 ppm to 7 wt. %, 1 wt. % to 7 wt. %, 2 wt. % to 7 wt. % based on the weight of the coating composition measured using EPA Method 24 dated Oct. 7, 2020.

In the coating compositions described above, the functional silane and optional polysiloxane and non-aromatic epoxy resin can be provided in a ratio of 20:80 to 80:20.

In addition to the functional silane, the coating compositions described above can include a polyurethane that can be the reaction product of reactants including an aliphatic polyisocyanate and a polyol, and can have a weight average molecular weight of 500 to 50,000 g/mol, such as 2,000 to 10,000 g/mol, absent the weight of any coordinated metal catalyst.

Nonlimiting examples of aliphatic polyisocyanates include at least aliphatic diisocyanates, such as hexamethylene diisocyanate (HDI), 4,4′-diphenylmethane diisocyanate (MDI), 2,4′-diphenylmethane diisocyanate, blends of 4,4′-diphenylmethane diisocyanate (MDI) with 2,4′-diphenylmethane diisocyanate, 2,4-toluene diisocyanate (TDI), 2,6-toluene diisocyanate, blends of 2,4-toluene diisocyanate (TDI) with 2,6-toluene diisocyanate, 1-isocyanato-3,3,5-trimethyl-5-isocyanatomethylcyclohexane (IPDI), dicyclohexylmethane-4,4′-diisocyanate, and combinations thereof. The diisocyanate may include a blend of 4,4′-diphenylmethane diisocyanate (MDI) with 2,4′-diphenylmethane diisocyanate (such as Mondur ML diisocyanate available from Covestro AG, Pittsburgh, Pa.). Nonlimiting examples of polyols include at least alkyl diols and higher functionality polyols, such as selected from polyether polyols, polyester polyols, and combinations thereof.

When the coating composition includes a cure system that includes a polyurethane coordinate with a metal catalyst, the cure system includes from 1 ppm, such as 5 ppm, or 9 ppm to 1000 ppm, such as 500 ppm or 150 ppm or 1 to 1000 ppm, such as 1 to 500 ppm, 1 to 150 ppm, 5 to 1000 ppm, 5 to 500 ppm or 5 to 150 ppm of the metal catalyst based on the total weight of the coating composition.

The present disclosure further provides coating composition that include a polysiloxane, a non-aromatic epoxide resin, and a cure system including (a) a silane-terminated polyurethane and (b) an alkoxy functional aminosilane, where the silane-terminated polyurethane (a) includes the reaction product of reactants including: (i) a polyurethane prepolymer component including a reaction product of reactants including a polyisocyanate, a polyol, and a metal catalyst, and (ii) an alkoxy functional silane different from the alkoxy functional aminosilane (b). The metal catalyst may be coordinated with the silane-terminated polyurethane.

The metal catalyst may be any of those disclosed hereinabove, such as those defined by the Metal catalyst formula above including manganese, zirconium, titanium, cobalt, iron, lead, bismuth, aluminum, zinc, or tin. The metal catalyst may be a metal amidine complex as defined hereinabove, i.e., having the formula M(A)₂(C)₂ where A represents an amidine, C represents a carboxylate, and Me represents zinc, zirconium, bismuth, or aluminum. In a nonlimiting example of an amidine complex, A may have one of the amidine formulas above. The metal catalyst includes zinc amidine or dibutyltin dilaurate. Moreover, the alkoxy functional aminosilane (b) of the cure system may be any of those having formulas II or III, as defined above.

The silane-terminated polyurethane of the cure system can include the reaction product of reactants including (i) a polyurethane prepolymer component and (ii) an alkoxy functional silane different from the alkoxy functional aminosilane (b), i.e., a silane endcap.

Nonlimiting examples of polyurethane prepolymers include the reaction product of reactants including an aliphatic diisocyanate and a polyol with a mole ratio of isocyanate groups to hydroxy groups of about 1:1 to about 2:1. Nonlimiting examples of aliphatic diisocyanates include hexamethylene diisocyanate (HDI), 4,4′-diphenylmethane diisocyanate (MDI), 2,4′-diphenylmethane diisocyanate, blends of 4,4′-diphenylmethane diisocyanate (MDI) with 2,4′-diphenylmethane diisocyanate, 2,4-toluene diisocyanate (TDI), 2,6-toluene diisocyanate, blends of 2,4-toluene diisocyanate (TDI) with 2,6-toluene diisocyanate, 1-isocyanato-3,3,5-trimethyl-5-isocyanatomethylcyclohexane (IPDI), dicyclohexylmethane-4,4′-diisocyanate, and combinations thereof. The diisocyanate may include a blend of 4,4′-diphenylmethane diisocyanate (MDI) with 2,4′-diphenylmethane diisocyanate. Nonlimiting examples of diols include at least alkyl diols.

Nonlimiting examples of alkoxy-functional silanes (ii) useful as endcaps in forming the silane-terminated polyurethane include silanes having the following formula:

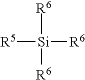

where R⁵ can be an isocyanate reactive functional group selected from R⁷NH—R⁹—, HO—R⁹—, and HS—R⁹—, where R⁷ may be selected from H and alkyl groups having 1-6 carbon atoms, and R⁹ may be selected from alkyl or alkylene groups having 1-10 linear, branched, or cyclic carbon groups; and each R⁶ can be independently selected from an aryl, alkyl, dialkylaryl, alkoxyalkyl, alkylaminoalkyl, or cycloalkyl radical, where at least one R⁶ includes an alkoxyalkyl. In a nonlimiting example of an alkoxy-functional silane (ii), R⁶ includes alkyl or alkoxyalkyl groups having 1-4 carbon atoms.

Nonlimiting examples of alkoxy functional silanes (ii) include aminosilanes, silanols, or mercaptosilanes having two methoxy groups, three methoxy groups, two ethoxy groups, three ethoxy groups, and combinations thereof. The aminosilane endcap can be selected from bis(trimethoxysilylpropyl)amine, 3-ethylamino-2-methylpropyl-trimethoxysilane, N-(n-butyl)-3-aminopropyl-trimethoxysilane, (3-mercapto propyl)-trimethoxysilane and combinations thereof. The silane terminated polyurethane can have a weight average molecular weight of 500 to 50,000 g/mol, such as 2,000 to 10,000 g/mol, absent the weight of the coordinated metal catalyst.

The silane terminated polymer of the cure system may be a polymer other than polyurethane, such as epoxy, amino, acrylamide, acryloxyl, acrylic, polyester, alkyd and hybrids thereof.

When the coating composition includes a cure system that includes a silane terminated polyurethane coordinate with a metal catalyst it may include from 1 ppm, such as 5 ppm, or 9 ppm to 1000 ppm, such as 500 ppm or 150 ppm or 1 to 1000 ppm, such as 1 to 500 ppm, 1 to 150 ppm, 5 to 1000 ppm, 5 to 500 ppm or 5 to 150 ppm of the metal catalyst based on the weight of the coating composition.

In the coating compositions of the present disclosure, the proportion of the cure system to resin component may vary over a wide range. The coating compositions may include from 70% to 90% by weight of the functional silane, optional polysiloxane and non-aromatic epoxy resin, and/or from 10% to 30% by weight of the cure system where the percent by weight is based on the total weight of the coating composition.

When an organic catalyst is included in any of the coating compositions described herein, either alone or in combination with a metal catalyst, the coating composition can include a cure system that includes a silane terminated polyurethane coordinate with an organic catalyst at from 1 ppm, such as 5 ppm, or 9 ppm to 1000 ppm, such as 500 ppm or 150 ppm or 1 to 1000 ppm, such as 1 to 500 ppm, 1 to 150 ppm, 5 to 1000 ppm, 5 to 500 ppm or 5 to 150 ppm of the organic catalyst based on the weight of the coating composition. The organic catalyst can be used alone at levels recited for the metal catalyst described herein.

The coating compositions described herein may include other components, including but not limited to, corrosion inhibitors, moisture scavengers, pigments, aggregates, rheological modifiers, plasticizers, antifoam agents, adhesion promoters, suspending agents, thixotropic agents, catalysts, pigment wetting agents, bituminous and asphaltic extenders, anti-settling agents, diluents, UV light stabilizers, air release agents, dispersing aids, solvents, surfactants, or mixtures of any thereof. One of ordinary skill in the resin coating compositions art would understand that other common components may be incorporated into the coating composition within the scope of the various aspects of the disclosure described herein. In specific examples, the coating composition may include up to 10% by weight of such components, combined or individually.

When the coating composition described herein additionally includes a corrosion inhibitor, the corrosion inhibitor can include, but is not limited to, zinc phosphate based corrosion inhibitors, for example, micronized HALOX SZP-391, HALOX 430 calcium phosphate, HALOX ZP zinc phosphate, HALOX SW-111 strontium phosphosilicate, HALOX 720 mixed metal phosphor-carbonate, and HALOX 550 and 650 proprietary organic corrosion inhibitors commercially available from Halox, Hammond, Ind. Other suitable corrosion inhibitors may include HEUCOPHOS ZPA zinc aluminum phosphate and HEUCOPHOS ZMP zinc molybdenum phosphate, commercially available from Heucotech Ltd, Fairless Hills, Pa. Corrosion inhibitors may be included into the coating composition in amounts of 1% to 7% by weight. The coating composition may additionally include a light stabilizer, such as liquid hindered amine light stabilizers (“HALS”) or UV light stabilizers. Examples of suitable HALS include, for example, TINUVIN® HALS compounds such as TINUVIN 292, TINUVIN 123, TINUVIN 622, TINUVIN 783, TINUVIN 770 commercially available from BASF, Ludwigshafen, Germany. Examples of suitable UV light stabilizers include, for example, CYASORB light stabilizers, such as CYASORB UV-1164L (2,4-bis(2,4-dimethylphenyl)-6-(2-hydroxy-4-isooctyloxyphenyl)-1,3,5-triazine), commercially available from Cytec Industries, Woodland Park, N.J. and TINUVIN 1130 and TINUVIN 328 commercially available from BASF, Ludwigshafen, Germany. The light stabilizer may be included into the coating composition in amounts of 0.25% to 4.0% by weight.

Suitable pigments for use in the coating compositions described herein may be selected from organic or inorganic color pigments and may include, for example, titanium dioxide, carbon black, lampblack, zinc oxide, natural and synthetic red, yellow, brown and black iron oxides, toluidine and benzidine yellow, phthalocyanine blue and green, and carbazole violet, and extender pigments including ground and crystalline silica, barium sulfate, magnesium silicate, calcium silicate, mica, micaceous iron oxide, calcium carbonate, zinc powder, aluminum and aluminum silicate, gypsum, feldspar and the like. The amount of pigment that may be used to form the composition can be understood to vary, depending on the particular composition application, and can be zero when a clear composition is desired. The coating composition may include up to 50% by weight fine particle size pigment or aggregate. Using greater than 50% by weight fine particle size pigment or aggregate ingredient may produce a composition that can be too viscous for application. In certain compositions where it is desirable to have more than 50% pigment or aggregate in the final composition, such as a zinc rich primer which contains up to 90% zinc in the dry film or a composition that may contain up to 80% pigment/aggregate, the pigment or aggregate may be packaged separately as a third component. Depending on the particular end use, the coating compositions may include from 20% to 35% by weight fine particle size aggregate or pigment.

The pigment or aggregate ingredient may typically be added to the epoxy resin portion of the resin component, for example, by dispersing with a Cowles mixer to at least 3 Hegman fineness of grind, or alternatively may be ball milled or sand milled to the same fineness of grind before addition of the polysiloxane ingredient. For example, selection of a fine particle size pigment or aggregate and dispersion or milling to 3 Hegman grind allows for the atomization of mixed resin and cure components with conventional air, air-assisted airless, airless and electrostatic spray equipment, and may provide a smooth, uniform surface appearance after application.

The polymeric compositions of this disclosure may be formulated for application with conventional air, airless, air-assisted airless and electrostatic spray equipment, brush, or roller. Moreover, the compositions may be used as protective coatings for ferrous and non-ferrous substrates, such as steel, galvanizing, aluminum, concrete and other substrates at dry film thicknesses in the range of from 25 micrometers to two millimeters. Accordingly, pigment or aggregate ingredients useful in forming the composition of the present disclosure may be selected from a fine particle size material, for example but not limited to, having at least 90 wt. % greater than 325 mesh U.S. sieve size.

The coating compositions of the present disclosure can be low in viscosity and can be spray applied without the addition of a solvent. However, organic solvents may be added to improve atomization and application with electrostatic spray equipment or to improve flow, leveling or appearance when applied by brush, roller, or standard air and airless spray equipment. Exemplary solvents useful for this purpose include, but are not limited to, esters, ethers, alcohols, ketones, glycols and the like. The amount of solvent added to compositions of the present disclosure may be limited by government regulation under the Clean Air Act to approximately 420 grams solvent per liter of the composition.

The coating compositions of the present disclosure may be supplied as a multi-package, multi-component, 2-pack or two-package system, for example, in moisture proof containers. A first package may contain the epoxy resin, polysiloxane resin, any pigment or aggregate ingredient, additives or solvent if desired. A second package may contain the cure system, including, for example, the alkoxy-functional aminosilane and an organic catalyst or a metal catalyst, or the polyurethane coordinated with the metal catalyst. The coating compositions of the present disclosure may be supplied as 3-package systems where the pigment or aggregate are supplied in a separate package e.g. for a flooring/concrete protection formulation or a zinc-rich primer coating.

The coating compositions of the present disclosure can be applied and fully cure at ambient temperature conditions in the range of from −6° C. to 50° C. At temperatures below −18° C. cure may be slowed. However, the coating compositions disclosed herein may also be applied under bake or cure temperatures up to 40° C. to 120° C.

While not wishing to be bound by any particular theory, it is believed that the coating compositions described herein are cured by: (1) the reaction of the epoxy resin with the cure system to form epoxy polymer chains; (2) the hydrolytic polycondensation of the functional silane and optional polysiloxane ingredients to produce alcohol and polysiloxane polymer; and (3) the copolymerization of the epoxy polymer chains with the polysiloxane polymer to form a fully-cured coating composition. The amine residue of the aminosilane of the cure system may undergo an epoxy-amine addition reaction and the silane moiety of the aminosilane may undergo hydrolytic polycondensation with the polysiloxane. In its cured form, the coating composition may exist as a uniformly dispersed arrangement of linear epoxy chain fragments that are cross-linked with a continuous polysiloxane polymer chain, thereby forming a non-interpenetrating polymer network (IPN) chemical structure that has substantial advantages over conventional epoxy systems.

In preparing the coating compositions of the present disclosure, the proportion of curing composition to resin component may vary over a wide range. In general, the epoxy resin may be cured with sufficient cure system where amine hydrogens react with the epoxide group of the epoxy resin to form epoxy chain polymers and with the urethane silane, ester silane and optional polysiloxane to form siloxane polymers, where the epoxy chain polymers and siloxane polymers may copolymerize to form the cured cross-linked polymer composition. Inclusion of the metal catalyst coordinate with a silane-terminated polyurethane effectively concentrates these curing agents in close proximity to the substrate, i.e., the epoxy and siloxane resins, effecting faster cure rates. This has the further advantage that the concentration of metal catalyst or organic catalyst in the system effective at providing rapid cure rates is greatly reduced, such that less than 1000 ppm, 100 ppm, or even 50 ppm metal catalyst is effective at providing rapid sure rates, as opposed to the greater than 10,000 ppm levels of the metal catalysts provided in prior art compositions.

The present disclosure also relates to coated substrates, where the substrate may have a surface coated with any of the coating compositions described herein. The coating compositions of the present disclosure may be applied to a desired substrate surface to protect it from weathering, impact, and exposure to corrosion or chemical(s). Illustrative substrates that may be treated using the coating compositions described herein include, but are not limited to, wood, plastic, concrete, vitreous surfaces, and metallic surfaces. The coating compositions described herein may find use as a top coating disposed either directly onto the substrate surface itself or disposed onto a prior or other underlying coating, e.g., an inorganic or organic primer coating, disposed on the substrate surface to achieve a desired purpose.

The present disclosure further relates to methods for protecting a surface of a substrate from the undesired effects of chemical(s), corrosion, and weather by coating a surface of the substrate, such as a substrate as described herein, with any of the coating compositions described herein. Methods for preparing the coating compositions can include forming a resin component, adding a cure system to the resin component to form a fully cured epoxy-modified polysiloxane coating composition, and applying the coating composition to the surface of the substrate to be protected before the coating composition becomes fully cured. The resin component may be formed by combining a functional silane and optional polysiloxane, and a non-aromatic epoxide resin having more than one 1,2-epoxide group per molecule with an epoxide equivalent weight in the range of from 100 to 5,000 g/mol. The cure system may be any of the cure systems described herein, such as (1) an organic catalyst; or (2) a blend of a trialkoxy functional aminosilane and a metal catalyst, such as zinc (II) amidine; or (3) a blend of a trialkoxy functional aminosilane and a polyurethane having a metal catalyst coordinated thereon; or (4) a blend of a trialkoxy functional aminosilane (a) and a silane-terminated polyurethane having a metal catalyst coordinated thereon (b), where the silane-terminated polyurethane is a reaction product of reactants including a polyurethane prepolymer and a silane endcap.

The substrates on which the coating composition can be applied include, as nonlimiting examples, metal, wood, concrete and/or plastic. The metal can be a ferrous (iron containg) or a non-ferrous metal. Further, the substrate can be, without limitation, steel, aluminum, galvanized steel, wood and/or concrete, such as in the maintenance of marine, construction, architectural, aircraft, automotive, and/or flooring.

The coating compositions described herein can be applied to a surface to be treated by conventional techniques such as spraying or brushing or the like and are usually applied in films of from 50 to 250 micrometers in thickness, or up to 1.5 millimeters in thickness. If necessary, multiple layers of the coating composition may be applied to the surface to be protected. For example, for use with a wooden substrate, such as in the furniture industry, the coating may be applied with a dry film thickness of 75 to 125 micrometers to provide a desired degree of protection to the underlying surface. On other surface structures, coatings of appropriate thickness may be applied to provide the desired level of protection. The coating composition, once applied to the surface of the substrate may be allowed to cure at ambient temperature until fully cured or, alternatively, may be cured at an elevated temperature, from ambient temperature up to 150° C. to 200° C., for example, by placing the coated substrate in a drying or curing oven. The substrate may be removed from the oven after complete curing of the coating composition or after partial curing of the coating composition, after which the coating composition may continue to cure on the substrate at ambient temperature until complete cure is attained.

These and other features of the coating compositions and coated substrates of the present disclosure will become more apparent upon consideration of the following examples. Whereas particular examples of this disclosure are described below for purposes of illustration, it will be evident to those skilled in the art that numerous variations of the details of the present disclosure may be made without departing from the disclosure as defined in the appended claims. All parts and percentages in the examples, as well as throughout this specification, are by weight unless otherwise indicated.

### EXAMPLES

### Example 1: Preparation of Polyurethane-Zinc Curing System

A 1-liter flask was equipped with a motor driven stainless steel stir blade, a water-cooled condenser, a nitrogen inlet, and a heating mantle with a thermometer connected through a temperature feedback control device. Added to the 1-liter flask was 155.1 g Desmodur N3600 (isocyanate), 9 g vinyl trimethoxy silane (VTMS), 0.2 g of Zinc Amidine (catalyst) and 207.2 g xylene (as in Example 2). The flask was heated to 50° C. At this temperature 14.7 g of 1,6-hexanediol (chain extender) was added while maintaining temperature below 60° C. This batch was held for 30 minutes at 60° C. After this hold, the in-process isocyanate equivalent weight was measured, and when it is found to be at about the theory equivalent weight of 665, a capping agent was added (138.1 g of Dynasylan1189) dropwise maintaining the temperature at below 70° C. After the addition, the batch was held for 30 minutes at 70° C. The reaction was monitored by the disappearance of the isocyanate NCO peak at 2200 cm-1 by Infra-Red spectroscopy, after which the heat was discontinued, and the batch cooled. The resulting polyurethane resin was 57% solids.

### Example 2: Preparation Michael Addition Product

A Michael addition product was prepared as follows from the ingredients listed below:

Charge 1

| Ingredient | Parts by weight |
|---|---|
| γ-aminopropyltrimethoxysilane | 60% |
| Silquest A1110, GE Silicones | |
| 1,6-hexanediol diacrylate | 40% |

Charge #1 was added to an appropriate sized, 4-necked flask equipped with a motor driven stainless steel stir blade, water-cooled condenser, and a heating mantle with a thermometer connected through a temperature feedback control device. The contents were stirred under a nitrogen blanket. Charge #2 was added at an appropriate rate to keep the temperature <60° C. Upon completion of Charge #2, the reaction temperature was set to 60° C. The reaction was held at temperature until the disappearance of the acrylate double bond was demonstrated by IR (peak at about 1621 cm⁻¹) and/or NMR (peaks at about 5.7-6.4 ppm) analysis.

### Examples a and 3-7 Coating Formulation

### Example A: Comparative

Component 1 of PSX 700 available from PPG Industries, a pigmented epoxy-silicone mixture was combined with component 2 of PSX 700, an amine-catalyst mixture that contains dibutyltin dilaurate (DBTDL).

Example 3 was prepared as outlined usingt xylene as in the amount indicated in Table 1.

Example 4 was prepared as outlined above except xylene was replaced with 1,6-hexanediol diacrylate in the amount indicated in Table 1.

Example 5 was prepared as outlined above except the polymer described in example 1 was replaced with Vestanat MF 203, available from Evonik, a catalyzed amino silane, in the amount indicated in Table 1.

Example 6 was prepared as outlined above except the polymer described in example 1 was replaced with Vestanat MF 205, available from Evonik, a catalyzed amino silane, in the amount indicated in Table 1.

Example 7 was prepared as outlined above except additional vinyl trimethoxy silane was included as indicated in Table 1.

Example 8 was prepared as outlined above except the Michael Addition product of example 2 was included in place of the polymer of example 1 as indicated in Table 1.

Coating formula Examples 3-8 and A were all prepared using a similar procedure: cure systems including an alkoxy functional aminosilane, a catalyst, or the resin complex from Example were mixed by weight fraction, according to Table 1. The intermediate was allowed to stand overnight and was then then mixed with 100 parts of a polysiloxane-epoxy resin. The drying properties were measured and recorded (Table 1).

A film of paint was applied with a BA-30 (Bird applicator) with an opening size of 150 microns. Drying properties were measured at 21° C., 60% relative humidity with a BK10 Dry Time Recorder (purchased from Cavey Laboratory Engineering Co. LTD) in accordance with ASTM-D5895 (2020). Properties of the applied paints are shown in Table 2.

TABLE 1

| | | | | | | |
|---|---|---|---|---|---|---|
| Examples | Ex 3 | Ex 4 | Ex 5 | Ex 6 | Ex 7 | Ex 8 |

part per weight

| | | | | | | |
|---|---|---|---|---|---|---|
| ¹polysiloxane - epoxy base | 100 | 100 | 100 | 100 | 100 | 100 |
| ²alkoxy functional aminosilane | 15.2 | 17.4 | 15.2 | 15.2 | 15.2 | 15.2 |
| ³DBTDL | 0 | <0.01 | 0 | 0 | 0 | 0 |
| ⁴HDDA | 0 | 2.4 | 0 | 0 | 0 | 0 |
| ⁵Xylene | 2.4 | 0 | 0 | 0 | 0 | 0 |
| ⁶Vinyltrimethoxy silane | 0 | 0 | 0 | 0 | 2.4 | 0 |
| Polymer Example 1 | 3.4 | 3.4 | 0 | 0 | 3.4 | 0 |
| ⁷catalyzed urethane silane | 0 | 0 | 5.76 | 0 | 0 | 0 |
| ⁸catalyzed urethane silane | 0 | 0 | 0 | 5.76 | 0 | 0 |
| Michael Addition Product, (ester | 0 | 0 | 0 | 0 | 0 | 5.76 |
| silane) of Example 2 | | | | | | |

¹component 1 of a pigmented epoxy-silicone mixture, PSX 700 available from PPG Industries
²3-aminopropyltriethoxysilane available from Sigma Aldrich
³DBTDL (Dibutyltin dilaurate) tin catalyst available from Sigma-Aldrich
⁴HDDA (1,6-Hexanediol diacrylate) available from Fisher Scientific
⁵Xylene (mixture of xylene isomers) available from Sigma-Aldrich
⁶Silquest A-171 available from Momentive
⁷Vestanat MF 203 available from Evonik
⁸Vestanat MF 205 available from Evonik

TABLE 2

| | Ex A | | | | | | |
|---|---|---|---|---|---|---|---|
| Examples | Comparative | Ex 3 | Ex 4 | Ex 5 | Ex 6 | Ex 7 | Ex 8 |
| Calculated metal catalyst | 14,000 | <100 | <100 | <100 | <100 | <100 | 0 |
| concentration in the final | | | | | | | |
| mixture, ppm | | | | | | | |
| 60% Humidity Dry Hard | 7.3 | 4.9 | 6.4 | 4.9 | 7.4 | 3.1 | 4.8 |
| Time @ ASTM- | | | | | | | |
| D5895 (2020), Hrs | | | | | | | |
| % solids @ ASTM-D5095 | 92 | 93 | 93 | 95 | 94 | 94 | 94 |
| (2013) | | | | | | | |
| Direct impact resistance, | 62.5 | 57.5 | >100 | 27.5 | 57.5 | 57.5 | 59 |
| in-lbs | | | | | | | |
| Indirect impact resistance, | 2.5 | 2.5 | 22.5 | 2.5 | 2.5 | 2.5 | 4 |
| in-lbs | | | | | | | |

As shown in Table 2, use of particular reactive diluents provide for improvement of certain physical properties of the final coating while maintaining or improving percent solids and lowering VOC levels. Use of HDDA (Example 4) improved flexibility. Use of vinyl silane (Example 7) improved dry times. The reactive diluents alter the overall chemistry of the coating in a unique way compared with acrylate addition.

The catalyzed urethane silane resins and Michael Addition Product ester silane resin improved dry times with similar solids and VOC levels compared to the control.

Whereas particular embodiments of this disclosure have been described above for purposes of illustration, it will be evident to those skilled in the art that numerous variations of the details of the present disclosure may be made without departing from the disclosure as defined in the appended claims.

1. A coating composition comprising:
(a) a functional silane;
(b) a non-aromatic epoxide resin; and
(c) a cure system that includes (i) an organic catalyst, and (ii) alkoxy functional aminosilane;
wherein the functional silane conforms to the formula:
UE-[-R²⁴Si(OR²⁵)₃]_{q}
wherein UE represents a moiety that includes one or more urethane, ester, thioether and/or thioester groups and q can be from 1 to 6;
wherein each R²⁴ is independently selected from —CH₂—, —CH₂CH₂—,
—CH₂CH₂CH₂—, —CH₂CH(CH₃)—,
—CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂—, —CH₂CH₂CH₂CH₂CH₂—, and —(CR⁵⁰₂)ᵥ—NR⁵⁰—(CR⁵⁰₂)ᵥ—; wherein each v is independently from 1 to 6 and each R⁵⁰ is independently selected from hydrogen, and C₁-C₄ alkyl; and
wherein each R²⁵ is independently selected from hydrogen and C₁-C₄ alkyl.

2. The coating composition according to claim 1, wherein the functional silane conforms to the formula:
(R²⁵O)₃Si—R²⁴-A-[-B—R²⁴Si(OR²⁵)₃]_{q}
wherein each A is independently C(R²³)₂ or N(R²³) and each R²³ is independently selected from hydrogen and C₁-C₄ alkyl and q can be from 0 to 5;
each B is independently selected from —C(O)—O—(R³⁰O)_{y}—, —C(O)—O—R³⁰-A-, —R³⁰—C(O)—O—R³⁰—O—C(O)—R³⁰-A-, —C(O)—O—[R³⁰—O—C(O)-A-R³⁰-A-C(O)—OR³⁰O]_{z}—C(O)-A-,
—C(O)—[O—R³⁰—O—C(O)-A-R³⁰-A-C(O)]_{z}-A-, and —[C(O)—N(R²³)—R³⁰—N(R²³)—C(O)—O—R³⁰—O—C(O)—N(R²³)—R³⁰—N(R²³)—C(O)]_{z}—N(R²³)—,
where each y is independently an integer from 1 to 20, each z is independently an integer from 1 to 20, and each R³⁰ is independently any C₁ to C₁₂ difunctional organic radical independently selected from aryl, linear or branched alkyl, linear or branched dialkylaryl, cyclo aliphatic and cycloalkyl radicals;
each R²⁴ is independently selected from —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂— or —CH₂CH₂CH₂CH₂CH₂—; and
each R²⁵ is independently selected from hydrogen and C₁-C₄ alkyl.

3. The coating composition according to claim 1, further comprising:
a polysiloxane and
(c) a reactive diluent
wherein the cure system comprises a polyurethane with a metal catalyst or an organic catalyst, and an alkoxy functional aminosilane;
wherein the coating composition contains less than 10 wt. % of volatile organic compounds based on the weight of the coating composition measured using EPA Method 24 dated Oct. 7, 2020.

4. (canceled)

5. The coating composition according to claim 1, wherein the functional silane conforms to the formula:
(R²⁵O)₃Si—R²⁴—N(R²³)-D-R²⁴Si(OR²⁵)₃
wherein each R²³ is independently selected from hydrogen and C₁-C₄ alkyl each D is independently selected from —C(O)—O—(R³⁰O)_{y}—, —C(O)—O—R³⁰—N(R²³)—, —R³⁰—N(R²³)—C(O)—O—R³⁰—O—C(O)—R³⁰—N(R²³)—, —C(O)—O—[R³⁰—O—C(O)—N(R²³)—R³⁰—N(R²³)—C(O)—OR³⁰O]_{z}—C(O)—N(R²³)—, —C(O)—[O—R³⁰—O—C(O)—N(R²³)—R³⁰—N(R²³)—C(O)]_{z}—N(R²³)—, and —[C(O)—N(R²³)—R³⁰—N(R²³)—C(O)—O—R³⁰—O—C(O)—N(R²³)—R³⁰—N(R²³)—C(O)]_{z}—N(R²³)—, where each y is independently an integer from 1 to 20, each z is independently an integer from 1 to 20, and each R³⁰ is independently any C₁ to C₁₂ difunctional organic radical independently selected from aryl, linear or branched alkyl, linear or branched dialkylaryl, cyclo aliphatic and cycloalkyl radicals;
each R²⁴ is independently selected from —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂— or —CH₂CH₂CH₂CH₂CH₂—; and
each R²⁵ is independently selected from hydrogen and C₁-C₄ alkyl; and/or
(R³⁴O)₃SiR³³N(R³²)C(O)O(CH₂CR³¹₂CR³¹₂CR³¹₂CR³¹₂CH₂O)_{z}C(O)N(R³²)R³³Si(OR³⁴)₃ wherein each R³¹ is independently selected from H, methyl, or ethyl, where each z is independently an integer from 1 to 10, each R³² is independently selected from hydrogen or methyl; each R³³ is independently selected from —CH₂CH₂—, —CH₂CH₂CH₂—, —CH₂CH(CH₃)—, —CH₂CH(CH₃)CH₂—,
—CH₂CH₂CH₂CH₂—,
—CH₂CH₂CH(CH₃)CH₂— and —CH₂CH₂CH₂CH₂CH₂—; and each R³⁴ is independently selected from hydrogen or methyl.

6. (canceled)

7. (canceled)

8. The coating composition according to claim 1, wherein the functional silane comprises a urethane silane that is a product prepared by reacting:
1) one or more C₁-C₂₀ linear, branched or cyclic alkyl mono-, di- and/or poly-functional alcohols, amines, and/or thiols, with
2) an isocyanate component containing up to six isocyanate groups, where the reaction product of 1) and 2) is reacted with
3) a compound containing an isocyanate-reactive group or an isocyanate group and one or more reactive silane groups in which at least 10 mole %, but less than 100% of component 3) is a compound corresponding to formula (I): 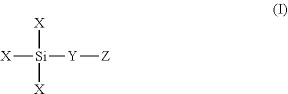
wherein
X represents the same or different organic groups that do not react with isocyanate groups below 100° C., provided that at least two of the groups are alkoxy or acyloxy groups,
Y represents a linear or branched alkylene group containing 1 to 8 carbon atoms, and
Z represents an isocyanate group, an amine group, a hydroxy group, or a thiol group; and/or
a product prepared by reacting:
1) an isocyanate component containing up to six isocyanate groups, with
2) a compound containing an isocyanate-reactive group or an isocyanate group and one or more reactive silane groups in which at least 10 mole %, but less than 100% of component 2) is a compound corresponding to the formula (I) 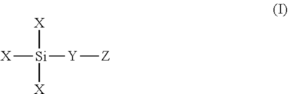
wherein
X represents the same or different organic groups that are inert to isocyanate groups below 100° C., provided that at least two of the groups are alkoxy or acyloxy groups,
Y represents a linear or branched alkylene group containing 1 to 8 carbon atoms, and
Z represents an isocyanate group, an amine group, a hydroxy group, or thiol group.

9. (canceled)

10. (canceled)

11. (canceled)

12. (canceled)

13. (canceled)

14. The coating composition according to claim 1, wherein the functional silane is an ester silane comprising compounds conforming to the formula:
(R²⁵O)₃Si—R²⁴-A-[-R²⁴—C—R²⁴-A-R²⁴—Si(OR²⁵)₃]_{q}
wherein each A is independently C(R²³)₂, N(R²³), —O— or —S— and each R²³ is independently selected from hydrogen and C₁-C₄ alkyl;
each C is independently selected from —C(O)—O—(R³⁰O)_{y}—, —C(O)—O—(R³⁰O)_{y}—C(O)—, and —C(O)—O—R³⁰—O—C(O)—, where each y is independently an integer from 1 to 20, and each R³⁰ is independently any C₁ to C₁₂ difunctional organic radical independently selected from aryl, linear or branched alkyl, linear or branched dialkylaryl, cyclo aliphatic and cycloalkyl radicals;
each R²⁴ is independently selected from —CH₂CH₂—, —CH₂CH₂CH₂—, —CH₂CH(CH₃)—, —CH₂CH(CH₃)CH₂—, —CH₂CH₂CH(CH₃)—, —CH₂CH₂CH₂CH₂—, —CH₂CH₂CH₂CH(CH₃)—, —CH₂CH₂CH(CH₃)CH₂— or —CH₂CH₂CH₂CH₂CH₂—; and
each R²⁵ is independently selected from hydrogen and C₁-C₄ alkyl; and/or
wherein the ester silane comprises a Michael addition reaction product of reactants comprising, (a) a compound comprising one or more than one site of ethylenic unsaturation, and (b) a functional silane;
wherein
(a) the compound comprising one or more than one site of ethylenic unsaturation comprises a mono-, di- and/or higher acrylates such as 1,6-hexanediol diacrylate, 1,4-butanediol diacrylate, ethylene glycol diacrylate, diethylene gycol diacrylate, tetraethylene glycol diacrylate, tripropylene glycol diacrylate, neopentyl glycol diacrylate, 1,4-butanediol dimethacrylate, poly(butanediol)diacrylate, tetraethylene glycol dimethacrylate, 1,3-butylene glycol diacrylate, triethylene glycol diacrylate, triisoproplene glycol diacrylate, polyethylene glycol diacrylate, bisphenol A dimethacrylate; triacrylates, trimethylolpropane triacrylate, trimethylolpropane trimethacrylate, pentaerythritol monohydroxy triacrylate, trimethylolpropane triethoxy triacrylate: pentaerythritol tetraacrylate, di-trimethylolpropane tetraacrylate; and/or dipentaerythritol (monohydroxy) pentaacrylate and mixtures or combinations thereof; and
(b) the functional silane comprises a a compound having the formula:
NH₂—R′—Si(R″)ₚ(O—R″′)₃₋ₚ, and/or
SH—R′—Si(R″)ₚ(O—R″′)₃₋ₚ,
wherein R′ is an alkylene group having from 2 to 10 carbon atoms, R″ is an alkyl, aryl, alkoxy, or aryloxy group having from 1 to 8 carbon atoms, R″′ is an alkyl group having from 1 to 8 carbon atoms, and p has a value of from 0 to 2.

15. (canceled)

16. (canceled)

17. (canceled)

18. (canceled)

19. The coating composition according to any of claim 3, wherein the reactive diluent is chemically integrated into a cured coating network.

20. (canceled)

21. The coating composition according to claim 3, wherein the reactive diluent is selected from amino-silicone hybrid compounds, aminoalkylmethylsiloxane-dimethylsiloxane copolymers, polyether amines, N,N′-dibutyldiaminodiphenylmethane, amine-functional resins, aliphatic diamines, 2-ethylhexyl glycidyl ether, 3,4-epoxycyclohexylmethyl-3′4′-epoxycyclohexane carboxylate, glycidyl esters of versatic acid, epoxy functional hydrophobic aliphatic, oxirane epoxidized linseed oils, propylene carbonate, 1,6-hexanediol diacrylate, butylacrylate, ethylhexylacrylate, vinyltrimethoxy silane, dimethylsiloxane-vinylmethylsiloxane-(propylene oxide-ethylene oxide) block copolymers, and tetraethoxysilane or a mixture or combination of any of the foregoing.

22. (canceled)

23. The coating composition according to claim 3, wherein the reactive diluent is present in the coating composition in an amount of from 0.5 to 10 wt. %, wherein the weight percentages are based on the weight of the coating composition.

24. The coating composition according to claim 3, wherein the metal catalyst, comprises a zinc, manganese, zirconium, titanium, cobalt, iron, lead, bismuth, or tin catalyst.

25. (canceled)

26. The coating composition according to claim 1, comprising a polyurethane comprising a silane terminated polyurethane.

27. (canceled)

28. The coating composition according to claim 1, comprising a polyurethane comprising a polyurethane prepolymer that is a reaction product of reactants comprising an aliphatic polyisocyanate and a diol, wherein the polyurethane optionally comprises the polyurethane prepolymer further reacted with an alkoxy functional silane, wherein the alkoxy functional silane has the formula: 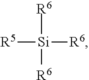
wherein
R⁵ is an isocyanate reactive functional group selected from NHR⁷, SH, and OH, wherein
R⁷ comprises H or an alkyl groups having 1-6 carbon atoms; and each R⁶ is independently selected from an aryl, alkyl, dialkylaryl, alkoxyalkyl, alkylaminoalkyl, or cycloalkyl radical, wherein at least one R⁶ comprises an alkoxyalkyl.

29. (canceled)

30. (canceled)

31. (canceled)

32. (canceled)

33. The coating composition according to claim 3, comprising 1 to 1000 ppm of the metal catalyst or organic catalyst based on the total weight of the coating composition.

34. The coating composition according to claim 1, comprising a polysiloxane having the formula: 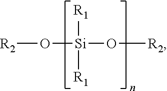
wherein
each R¹ is independently selected from a hydroxy group or an alkyl, aryl, or alkoxy group having up to six carbon atoms,
each R² is independently selected from hydrogen, or an alkyl or aryl group having up to six carbon atoms, and
n is selected so that the weight average molecular weight for the polysiloxane is 400 to 10,000 g/mol; and/or
wherein the alkoxy functional aminosilane comprises a general formula 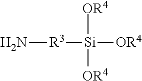
wherein,
R³ is a difunctional organic radical comprising an aryl, alkyl, dialkylaryl, alkoxyalkyl, alkylaminoalkyl, or cycloalkyl radical, and
each R⁴ is independently selected from an alkyl, hydroxyalkyl, alkoxyalkyl, or hydroxyalkoxyalkyl group comprising less than six carbon atoms.

35. (canceled)

36. (canceled)

37. (canceled)

38. (canceled)

39. (canceled)

40. (canceled)

41. (canceled)

42. The coating composition according to claim 1, wherein the organic catalyst is selected from bicycloguanidine, an imidazole, an acid catalyst, an aliphatic or cyclic amine, a phosphonium salt, a phenolic acid or salt, a sulphonic acid or salt, a tertiary amine and a quaternary ammonium salt or a mixture or combination of any of the foregoing.

43. (canceled)

44. (canceled)

45. (canceled)

46. The coating composition according to claim 1 wherein volatile organic compounds are present in an amount of 10 wt. % or less wherein the weight percentages are based on the total weight of the coating composition.

47. The coating composition according to claim 1, wherein the urethane silane comprises a compound having a structure selected from: 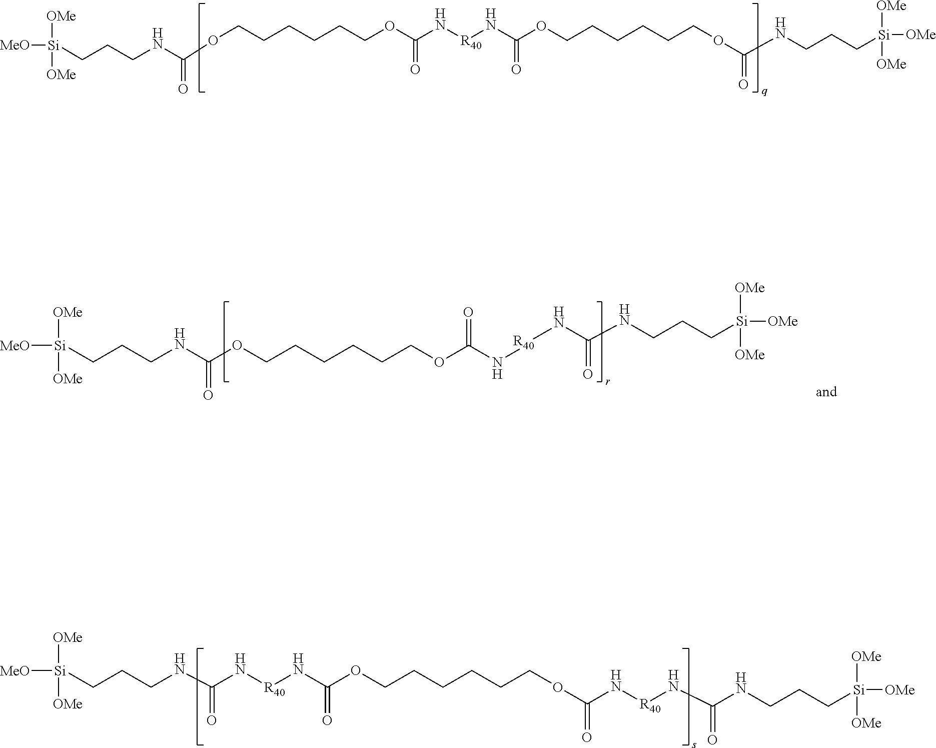
or a mixture or combination thereof,
wherein each R⁴⁰ is independently a C₁ to C₁₂ difunctional organic radical independently selected from aryl, linear or branched alkyl, linear or branched dialkylaryl, cyclo aliphatic and cycloalkyl radicals, such as, toluene, 4,4′-methylene-bis(cyclohexane), isophorone, 2,2,4-trimethyl hexane, 2,4,4-trimethyl hexane, 1,6-hexane, tetramethyl xylylene and 4,4′-diphenylmethylene; and/or
wherein the functional silane comprises an ester silane comprising a compound having a structure selected from: 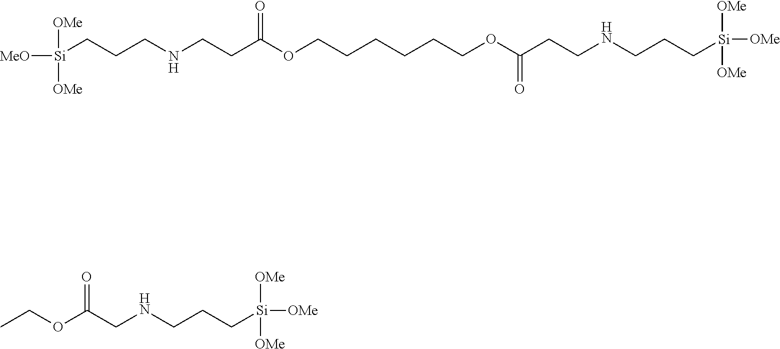 [SMILES: CO[Si](CCCNCCC(=O)OCCCCCCOC(=O)CCNCCC[Si](OC)(OC)OC)(OC)OC ; CCOC(=O)CNCCC[Si](OC)(OC)OC]
or a mixture or combination thereof.

48. (canceled)

49. A coated substrate comprising a surface at least partially coated with a coating composition according to claim 1.

50. A method for coating a surface with a coating composition, the method comprising:
preparing a coating composition according to claim 1;
and
applying the coating composition to at least a portion of a surface of a substrate to be protected before the coating composition becomes fully cured;
wherein the coating composition is applied to the surface of the substrate using conventional air, airless, air-assisted airless, electrostatic spray, brush, and/or roller application; and
wherein the substrate comprises a ferrous and/or non-ferrous metal, wood, concrete and/or plastic.

51. (canceled)

52. (canceled)

53. (canceled)

54. The coated substrate according to claim 18, wherein the substrate comprises steel, aluminum, galvanized steel, wood and/or concrete, such as in the maintenance of marine, construction, architectural, aircraft, automotive, and/or flooring.
